(19) United States
(12) Patent Application Publication
(10) Pub. No.: US 2013/0215126 A1
(43) Pub. Date: Aug. 22, 2013

(54) Managing Font Distribution

(71) Applicant: Christopher J. Roberts, Andover, MA (US)

(72) Inventor: Christopher J. Roberts, Andover, MA (US)

(73) Assignee: Monotype Imaging Inc.

(21) Appl. No.: 13/399,146

(22) Filed: Feb. 17, 2012

(51) Int. Cl. G06T 1/00

(52) U.S. Cl. 345/522

(57) ABSTRACT

A system includes a first computing device that includes a memory configured to store instructions. The first computing device also includes a processor to execute the instructions to perform a method that includes receiving, at a font service provider, a request from a second computing device for one or more fonts. The method also includes authenticating the user of the second computing device from the received request, and, providing access to data representative of the one or more fonts identified in the received request for use by the second computing device. The data representative of the one or more fonts resides in a predefined portion of memory assigned to the user of the second computing device.

### BACKGROUND

This description relates to techniques for managing the accessibility and distributions of fonts and related information.

As more and more web assets are created for businesses, individuals and other types of applications, interest has correspondingly grown to incorporate different types of content into these assets. Including content such as photographs, video, audio, etc., the web asset may become more attractive to end viewers such as potential customers. To assist with or possibly manage a major portion of a web asset development, one or more specialists (e.g., developers) may be utilized. Web asset mockups may be created to provide information to the specialists tasked with producing the web asset. As such, along with developers and other types of specialists, mockup-creating individuals may also be interested in the content used for web asset development.

### SUMMARY

The systems and techniques described here relate to managing the distribution of fonts. Along with efficiently providing access to the fonts, subscriptions, rental periods and other types of techniques may be implemented for managing the font distribution.

In one aspect, a computing device-implemented method includes receiving, at a font service provider, a request from a computing device for one or more fonts. The method also includes authenticating the user of the computing device from the received request, and, providing access to data representative of the one or more fonts identified in the received request for use by the computing device. The data representative of the one or more fonts resides in a predefined portion of memory assigned to the user of the computing device.

Implementations may include one or more of the following features. The one or more fonts identified in the received request may supplement one or more other fonts residing in a portion of memory for fonts of the computing device. The predefined portion of memory assigned to the user may be included in the computing device. The predefined portion of the memory assigned to the user may be located at the font service provider. The predefined portion of the memory assigned to the user may be located at another service provider. Authenticating the user of the computing device may include determining if the user has a current subscription for access to fonts of the font service provider. Providing access to data representative of the one or more fonts identified in the received request may include adding the data representative of the one or more fonts to the predefined portion of memory assigned to the user, which is included in the computing device. Authenticating the user of the computing device may include determining which fonts are accessible based upon a subscription of the user. Authenticating the user of the computing device may include determining the status of a rental period.

In another aspect, a system includes a first computing that includes a memory configured to store instructions. The first computing device also includes a processor to execute the instructions to perform a method that includes receiving, at a font service provider, a request from a second computing device for one or more fonts. The method also includes authenticating the user of the second computing device from the received request, and providing access to data representative of the one or more fonts identified in the received request for use by the second computing device. The data representative of the one or more fonts resides in a predefined portion of memory assigned to the user of the second computing device. The one or more fonts identified in the received request may supplement one or more other fonts residing in a portion of memory for fonts of the second computing device. The predefined portion of memory assigned to the user may be included in the second computing device. The predefined portion of the memory assigned to the user may be located at the font service provider. The predefined portion of the memory assigned to the user may be located at another service provider. Authenticating the user of the second computing device may include determining if the user has a current subscription for access to fonts of the font service provider. Providing access to data representative of the one or more fonts identified in the received request may include adding the data representative of the one or more fonts to the predefined portion of memory assigned to the user, which is included in the second computing device. Authenticating the user of the second computing device may include determining which fonts are accessible based upon a subscription of the user. Authenticating the user of the computing device may include determining the status of a rental period.

In another aspect, one or more computer readable media storing instructions that are executable by a processing device, and upon such execution cause the processing device to perform operations that include receiving, at a font service provider, a request from a computing device for one or more fonts. Operations also include authenticating the user of the computing device from the received request, and, providing access to data representative of the one or more fonts identified in the received request for use by the computing device. The data representative of the one or more fonts resides in a predefined portion of memory assigned to the user of the computing device.

Implementations may include one or more of the following features. The one or more fonts identified in the received request may supplement one or more other fonts residing in a portion of memory for fonts of the computing device. The predefined portion of memory assigned to the user may be included in the computing device. The predefined portion of the memory assigned to the user may be located at the font service provider. The predefined portion of the memory assigned to the user may be located at another service provider. Authenticating the user of the computing device may include determining if the user has a current subscription for access to fonts of the font service provider. Providing access to data representative of the one or more fonts identified in the received request may include adding the data representative of the one or more fonts to the predefined portion of memory assigned to the user, which is included in the computing device. Authenticating the user of the computing device may include determining which fonts are accessible based upon a subscription of the user. Authenticating the user of the computing device may include determining the status of a rental period.

These and other aspects and features and various combinations of them may be expressed as methods, apparatus, systems, means for performing functions, program products, and in other ways.

Other features and advantages will be apparent from the description and the claims.

### DESCRIPTION OF DRAWINGS

FIG. 1 illustrates a system for managing the distribution of fonts.

FIG. 2 illustrates a font service provider transferring fonts to a client computing device.

FIG. 3 illustrates an intermediate service provider and a font service provider distributing fonts to a client computing device.

FIG. 4 is a representative flow chart of operations for managing the distribution of fonts to client computing devices.

FIG. 5 is a block diagram showing an example of a system for providing hosted storage and accessing the hosted storage from a client device.

FIG. 6 illustrates an example of a computing device and a mobile computing device that can be used to implement the techniques described here.

### DETAILED DESCRIPTION

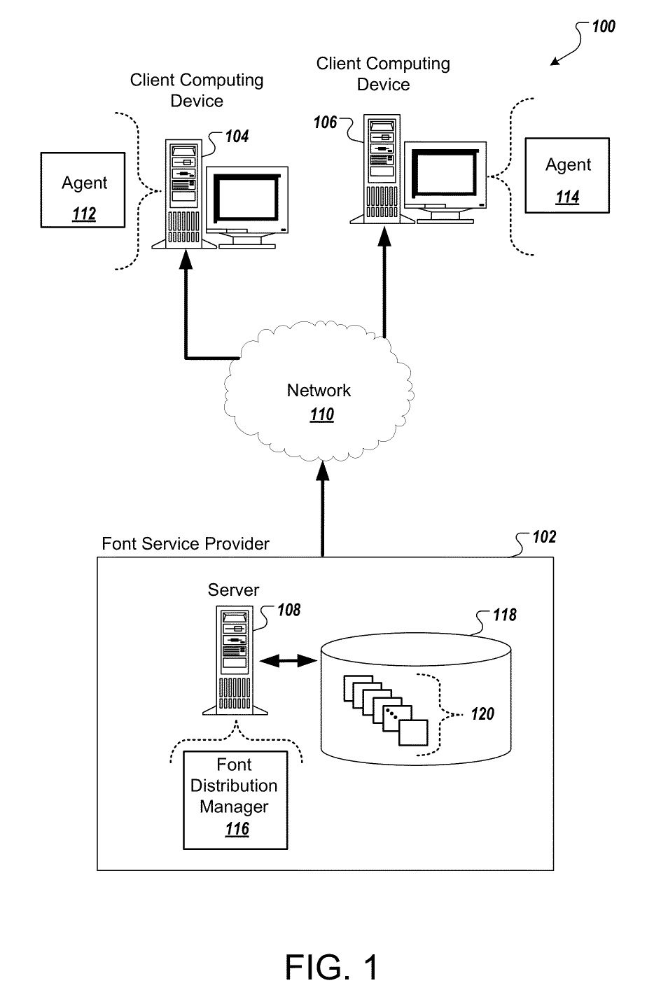

Referring to FIG. 1, a relatively simplified representation of a font distribution system 100 illustrates the delivery of fonts from a font service provider 102 to client computing devices. For demonstrative purposes two computer systems 104, 106 are illustrated to represent the many possible client computing devices that could potentially be delivered fonts. To provide the fonts, the font service provider 102 includes one or more servers (e.g., represented by a server 108) that can establish communication connections with the client computing devices. In this example, a network 110 (e.g., the Internet) is used for exchanging data among the font service provider 102 and the client computing devices; however, other networking architectures including the use of multiple networks may be implemented. In some arrangements, the font service provider 102 may be considered as being implemented as a cloud computing architecture in which its functionality is perceived by the client computing devices as a service rather than a product. For such arrangements, the client computing devices are provided fonts from one or more shared resources (e.g., hardware, software, information, etc.) used by the font service provider 102. For service compensation, one or more techniques may be utilized; for example, subscription plans for various time periods may be implemented (e.g., a monthly subscription fee for access to a fixed number of fonts). In some arrangements, rental plans may be implemented such that selected fonts, predefined fonts, etc. may be used during a predefined rental period. Once exceeded, access to the selected fonts may be blocked; however, in some arrangements, a client computing device may be allowed to exceed the rental period, e.g., for a relatively small predefined time period that may or may not call for an additional fee. For such services, the font service provider 102 may communicate with the client computing devices to provide information such as status updates, subscription and rental period termination warnings, etc. For example, the computer systems 104, 106 may receive electronic mail messages or other types of communication from the font service provider 102. Along with developers tasked to create web assets (e.g., websites, webpages, etc.) being provided easily accessible fonts and related information, individuals and organizations can also engage the font service provider 102 for asset creations (e.g., produce initial mock-ups of web assets to provide to developers for detailed production and delivery).

One or more techniques and methodologies may be implemented for client computing devices to establish relationships with the font service provider 102 and for the font service provider 102 to control the distribution of fonts. For example, to communicate with the font service provider 102, a client-side application (e.g., an executable agent, etc.) may need to be executed by a corresponding client computing device. As illustrated in the figure, an agent 112 may be loaded onto and executed by the computer system 104, and, a similar agent 114 may be loaded onto and executed by the client computer system 106. On the font service provider 102 side, a font distribution manager 116 may be executed by the server 108, for example, to manage the access and delivery of the fonts (e.g., through the network 110) that are controlled by the font service provider. For illustration, the server 108 is shown to be in communication with a storage device 118 (e.g., one or more hard drives, CD-ROM, memories, etc.) that stores a vast collection of fonts 120. While the figure illustrates the collection of fonts 120 being stored in single device (e.g., the storage device 118) at a single location (e.g., the font service provider 102), the font distribution manager 116 may access and manage (e.g., by way of one or multiple networks) one or more font collections distributed among different locations (e.g., internal or external to the font service provider 102) and stored on two or more storage devices. While agents are provided to and executed by the client computing devices, in some arrangements, a client-side application may not be needed for communicating with the font service provider 102. For example, communication with the font service provider 102 may be initiated from a web asset (e.g., website, web page, etc.) that is presented by a web browser application being executed by a client computing device.

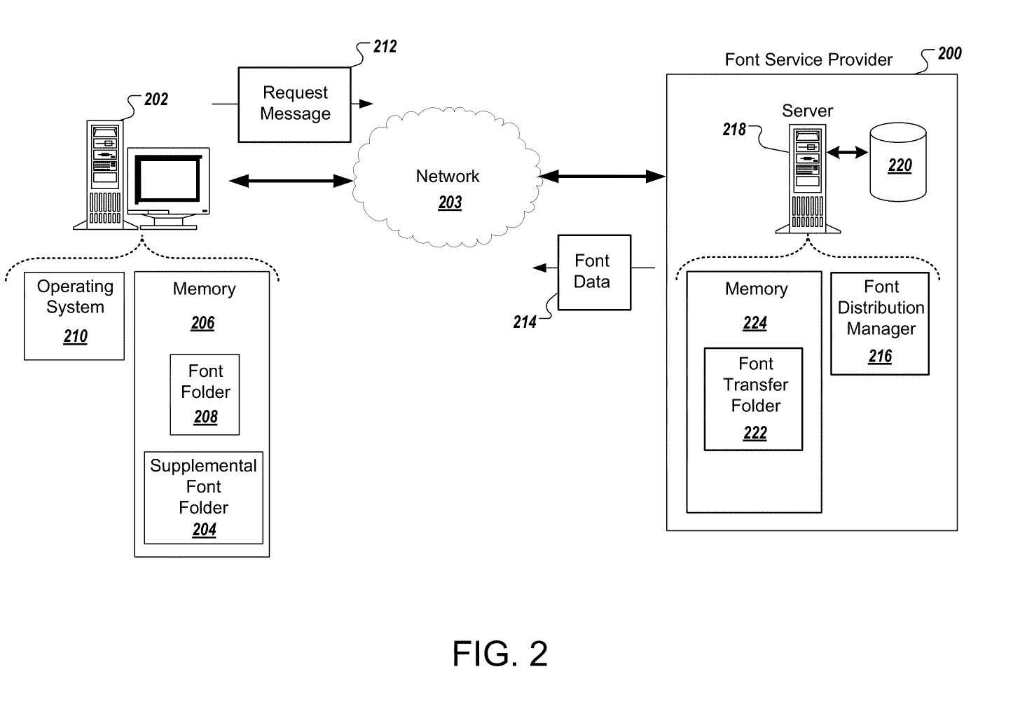

Referring to FIG. 2, one or more techniques and methodologies may be implemented for distributing fonts from a font service provider 200 to a client computer system 202 (e.g., by way of a network 203). For example, after establishing a relationship with the font service provider (e.g., entering into a subscription agreement), a supplemental font folder 204 may be placed (e.g., created) into memory 206 (e.g., random access memory (RAM), etc.) of the client computer system 202. Often computing devices such as the client computer system 202 include a collection of fonts that are accessible by the operating system of the device, e.g., for use by applications executed by the device. These included fonts are often stored together in a portion of memory that is accessible by the operating system. As illustrated in the figure, a font folder 208 resides in memory 206 and can be accessed by an operating system 210 of the client computer system 202. However, the fonts included in the font folder 208 may be considered a limited collection of fonts (e.g., fonts in the collection are selected during development of the operating system). As such, the font folder 208 may not contain more recently developed fonts and its limited collection may not include the considerably larger collections at the disposal of the font service provider 200. By providing additional fonts into the supplemental font folder 204, the client computer system 202 is capable of producing web assets that include a larger variety of fonts (compared to the font collection of the font folder 208).

To be provided additional fonts, for storing in the supplemental font folder 204, in some arrangements a request is sent to the font service provider 200. For example, a message 212 that contains client identification information (e.g., user name, password, etc.) may be provided to the font service provider 200. In some arrangements, an agent executed by the client computer system 202 may initiate the preparing and sending of the message 212. Along with identification information, the message may also include additional information (e.g., font selections, subscription information, etc.). Upon authenticating the identity of the client (e.g., confirm the client's identity from the contents of the message) and the validity of the client's relationship with the font service provider (e.g., the client's subscription is still in force, a rental period has not expired, etc.), the font service provider 200 may prepare and send font data 214 (e.g., a file, multiple files, a message with file attachment(s), etc.) to the client computer system 202. Upon receipt, the font data is directed to the supplemental font folder 204 in the memory 206 and the newly delivered fonts can be accessed by the operating system 210 of the computer system 202 (e.g., for use in one or more applications for web asset mockup, development, etc.).

One or more techniques may be implemented to provide fonts from the font service provider 200 to the client computer system 202 to enhance development capabilities, e.g., for web asset production. For example, a font distribution manager 216 executed by a server 218 located at the font service provider 200 may be able to gather the appropriate fonts (e.g., based upon the message 212 received from the client computer system 202, a subscription agreement with the client, etc.), for example, from a storage device 220. Once gathered, the font distribution manager 216 may provide data representative of the collection of fonts to a font transfer folder 222 that resides in memory 224 of the server 218. Sent data that represents the fonts (e.g., in a file 214, multiple files, a message, etc.), the client computer system 202 may direct the font data to the supplemental font folder 204. By sending the data, the fonts contained in the supplemental font folder 204 can be considered as matching the fonts contained in the font transfer folder 222. In some arrangements the font transfer folder 222 can be considered as being linked to the supplemental font folder 204 such that the font distribution manager 216 monitors the content of the font transfer folder 222 (e.g., senses any newly added fonts, etc.) and updates the supplemental font folder 204 as needed. In some arrangements, the font transfer folder 222 may be continuously monitored, periodically monitored (e.g., every few minutes, hourly, daily, etc.), etc. Monitoring may also be triggered by one or more events (e.g., detected events). For example, upon data being placed in the font transfer folder 222, the font distribution manager 216 may detect this event and initiate operations (e.g., producing a copy of the data and send the copy to the client computer system 202) to have the data placed in the supplemental font folder 204. In some arrangements, the font distribution manager 216 may monitor the activity of the supplemental font folder 204 and correspondingly update the font transfer folder 222. For example, upon detecting data (e.g., font data) has been added, altered and/or deleted within the supplemental font folder 204 (e.g., as provided by a message from an agent being executed by the client computer system), the font transfer folder 222 may be similarly updated such that substantially identical information resides in both folders. In some arrangements the font transfer folder 222 may be used for tracking the fonts provided to an individual client, or, in other arrangements, the font transfer folder may be used for tracking fonts provided to multiple clients. Also, in some arrangements the font data provided to the supplemental font folder 204 may be restricted to that portion of the memory 206, however, in other arrangements, the font data may be transferable to other locations such as a storage device for backup (e.g., based upon the subscription entered into with the font service provider 200). Besides utilizing two (or more) folders to provide additional fonts to a client computing device, other architectures may be implemented.

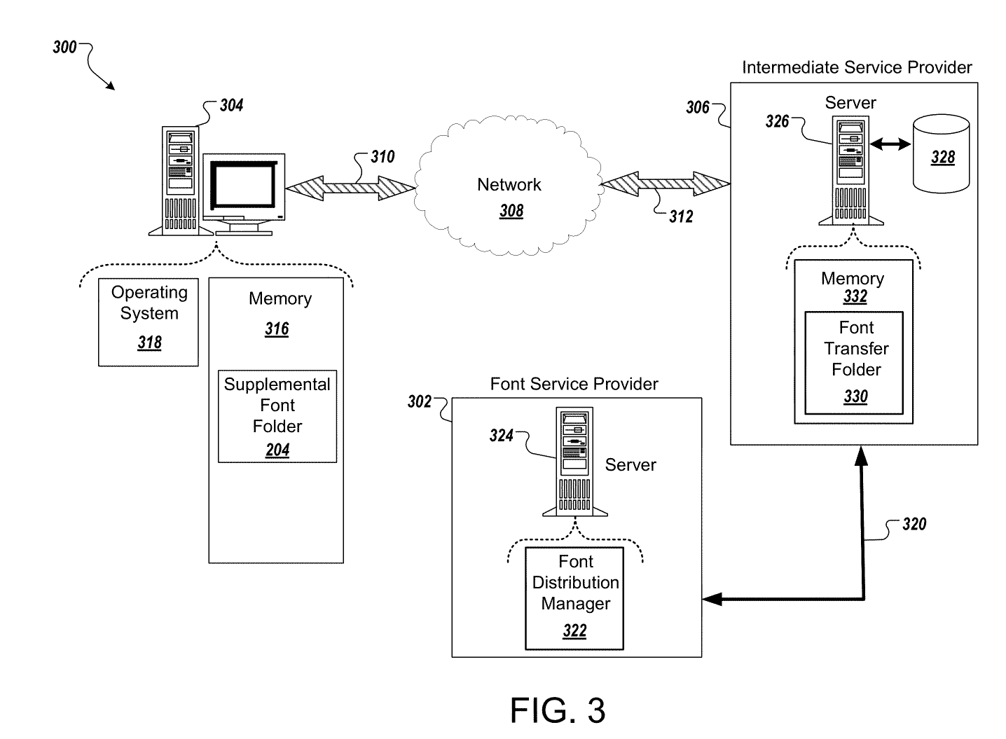

Referring to FIG. 3, the architecture of an example font distribution system 300 illustrates the use of an intermediate service provider for delivering fonts to client computing devices. For demonstrative purposes, the distribution system 300 illustrates fonts being provided from a font service provider 302 to a single client computer system 304, however, similar to other architectures, the system can be considered scalable for delivering fonts to many client computing devices and different types of computing devices (e.g., computer systems, cellular telephones, tablet computers, smart devices, etc.). In this example, an intermediate service provider 306 is utilized by the font service provider 302 for delivering the fonts to the client end-users. Such intermediaries may more efficiently and cost-effectively provide a portion of the distribution functionality. In this illustrative example, the single intermediate service provider 306 is inserted into the delivery chain between the font server provider 302 and client computer system 304. To improve font delivery, the intermediate service provider 306 may provide various types of enhanced capabilities. For example, faster data transmission to and from the client computer system 304 (e.g., through a network 308 such as the Internet) may be achievable by the intermediate service provider 306 rather than incorporating such capability into the font service provider 302 (which may be less than cost-effective). In this example, relatively fast-speed communication such as communicating in a substantially continuous manner while also being used, e.g., streaming, (as represented by the hashed arrows 310 and 312) may be achieved between the client computer system 304, the network 308 and the intermediate service provider 306. As such, font data may be quickly provided to a supplemental font folder 314 residing in memory 316 of the client computer system 304. Once resident, the fonts of the supplemental font folder 314 may be accessed by an operating system 318 of the client computer system 304 and used for various applications.

While the intermediate service provider 306 may provide enhanced capabilities (e.g., faster transmission speeds, larger bandwidth, increased throughput, faster accessible memory, etc.) for communicating through the network 308, corresponding capabilities of the font service provider 302 may be less in some respects. For example, data transmission speeds between the font service provider 302 and the intermediate service provider 306 may be lower, as graphically represented with the solid, thin arrow 320. As such, a font distribution manager 322 executed by a server 324 at the font service provider 302 may provide information in less than a time critical manner to the intermediate service provider 306 (e.g., send a list of valid subscribers to a server 326, send a copy of the entire font catalog for local storage on a storage device 328 of the intermediate service provider 306, etc.). Having the enhanced capabilities, the intermediate service provider 306 may execute more time critical operations such as quickly authenticating clients (e.g., based upon a received request message), providing font data directly to the supplemental font folder 314 as needed, sending time critical messages (e.g., rental period terminated, subscription payment due, etc.), etc. In some arrangements, the architecture may include a font transfer folder 330 (e.g., in a memory 332) for tracking fonts provided to the client computer system, however, in some arrangements, such a transfer folder may not be warranted (e.g., due to the transmission speed for directly providing fonts to the supplemental font folder 314). As such, tracking the fonts provided to a client computing device may be provided by one or more other techniques (e.g., using a log for fonts requested, transferred, etc. for one or multiple clients). In some arrangements, if two (or more) folders are not needed for tracking fonts being provided to client computing devices (e.g., a file transfer folder and a supplemental font folder), font data may be directly provided from a font service provider (or an intermediate service provider) to a portion of memory of a client computing device used to store font data (e.g., font folder 208 shown in FIG. 2) and that is accessible by an operating system.

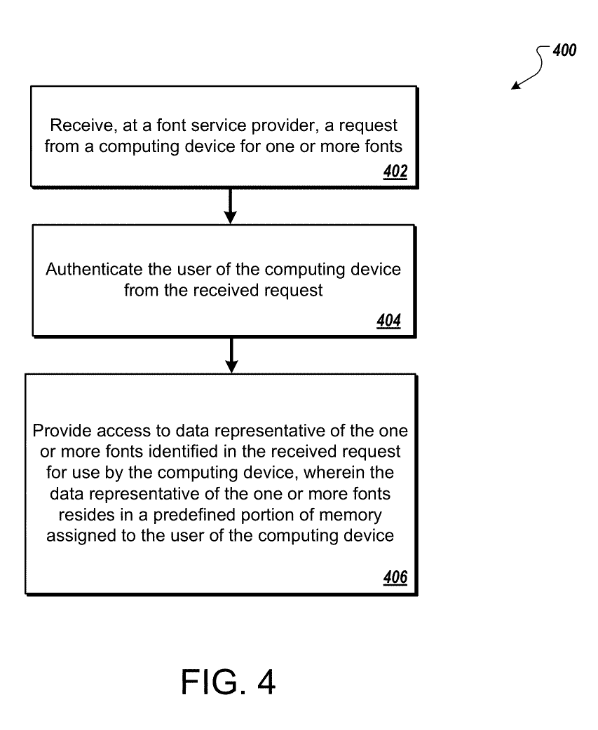

Referring to FIG. 4, a flowchart 400 represents operations of a computing device such as the server 218 (shown in FIG. 2) to manage the distribution of fonts to one or more client computing devices. Such operations, e.g., of the font distribution manager 216 (also shown in FIG. 2), are typically executed by components (e.g., processors, memory controllers, etc.) included in a single computing device (e.g., the server 218 of FIG. 2); however, operation may be executed by multiple computing devices. Along with being executed at a single site (e.g., the font service provider 200 of FIG. 2), operation execution may be distributed among two or more locations.

Operations may include receiving 402, at a font service provider, a request from a computing device from one or more fonts. For example, after viewing one or more font collections (e.g., on a web page provided by an executed web browser) and indicating an interest in being provided a selection from the collections, a request may be provided to the font service provider (e.g., from an agent being executed by the computing device, from the web browser, etc.). Operations may also include authenticating 404 the user of the computing device from the received request. For example, the identity of the requester may be checked prior to providing access to the fonts. A contractual arrangement may also be checked prior to providing access. For example, the font service provider may check to ensure that the user has appropriately agreed to a subscription (or has a currently valid subscription), a rental service (or there is a currently open rental period), etc. Operations may also include providing 406 access to data representative of the one or more fonts identified in the received request for use by the computing device. The data representative of the one or more fonts resides in a predefined portion of memory assigned to the user of the computing device. For example, identified fonts may be placed into a portion of memory (e.g., for holding the content of a font transfer folder at the font service provider) that may be linked to a corresponding portion of memory at the computing device (e.g., a memory portion for holding content of a supplemental font folder). By updating the contents of the memory portions to be current, the computing device has access to the fonts provided by the font service provider. Other architectures may also be implemented, for example, fonts may be directly provided from the font service provider (or through one or more intermediaries) to the memory of the computing device (e.g., to a font folder, a supplemental font folder, etc.), for example, as requested.

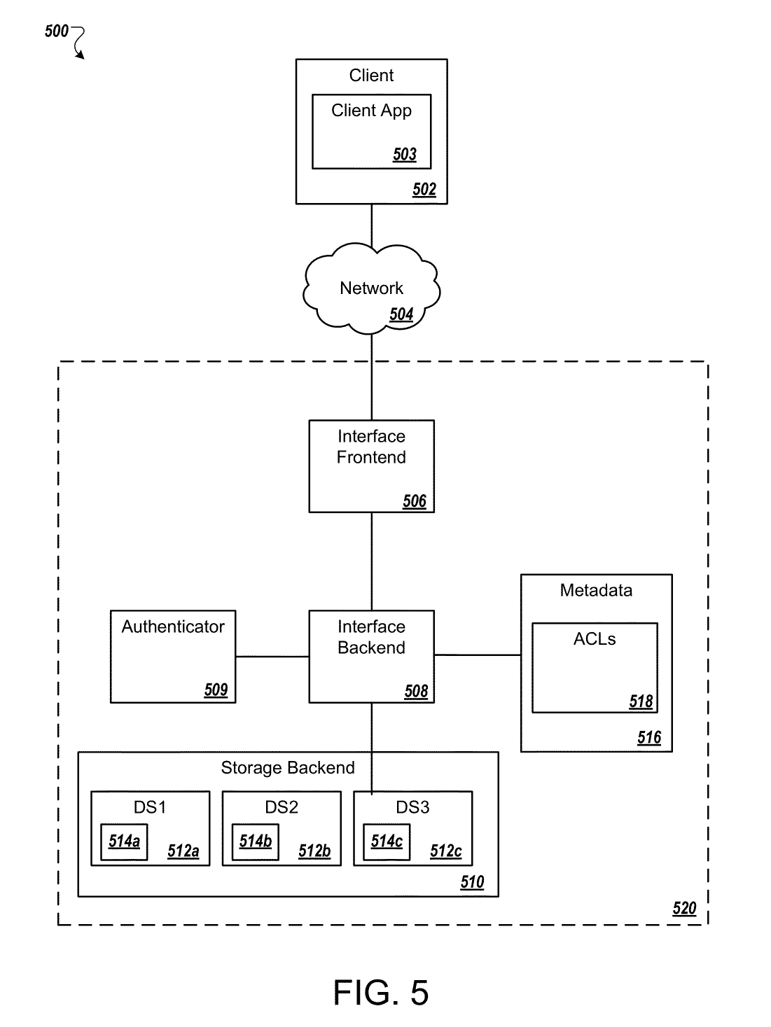

FIG. 5 is a block diagram showing an example of a system 500 for providing hosted storage and accessing the hosted storage from a client device 502. In some implementations, a hosted storage service 520 may provide access to stored data by applications running on computing devices operating separately from one another, provide offsite data backup and restore functionality, provide data storage to a computing device with limited storage capabilities, and/or provide storage functionality not implemented on a computing device.

The system 500 may provide scalable stores for storing data resources. The client device 502 may upload data resources to the hosted storage service 520 and control access to the uploaded data resources. Access control may include a range of sharing levels (e.g., private, shared with one or more individuals, shared with one or more groups, public, etc.). Data stored in hosted storage service 520 can be secured from unauthorized access. The hosted storage service 520 can use a simple and consistent application programming interface, or API, which can allow arbitrary quantities of structured or unstructured data to be kept private or shared between individuals, organizations, or with the world at large. The client device 502 may access, retrieve, be provided, store, etc. data in the hosted storage service 520 for any number of a variety of reasons. For example, data may be stored for business reasons (e.g., provide identification information to attain access clearance for font data at the hosted storage service 520), or for use in data processing by other services.

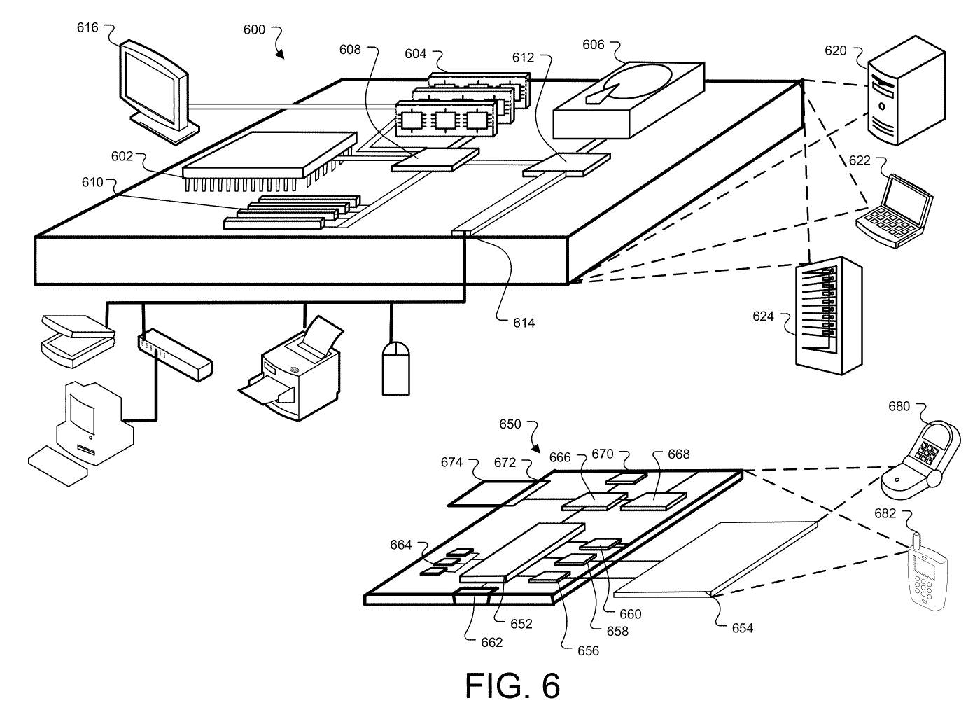

The client device 502 may be implemented using a computing device, such as the computing device 600 or the mobile device 650 described with respect to FIG. 6. The client device 502 may communicate with the hosted storage service 520 via a network 504, such as the Internet. The client device 502 may communicate across the network using communication protocols such as, for example, one or more of Transmission Control Protocol/Internet Protocol (TCP/IP), Hypertext Transfer Protocol (HTTP), Secure Shell Remote Protocol (SSH), or Application Program Interfaces (API). While only a single client device 502 is shown, there may be multiple client devices communicating across the network 504 with the hosted storage service 520 and/or other services and devices.

The hosted storage service 520 may be implemented such that client applications executing on client device 502, such as a client application 503, may store, retrieve, or otherwise manipulate data resources in the hosted storage service 520. The hosted storage service 520 may be implemented by one or more server devices, which may be implemented using a computing device, such as the computing device 600 or mobile device 650 described with respect to FIG. 6. For example, the hosted storage service 520 may be implemented by multiple server devices operating in the same, or different, data centers.

The hosted storage service 520 generally includes an interface frontend 506, an interface backend 508, a storage backend 510, and metadata 516 for resources stored in the storage backend 510. The hosted storage service 520 may also include an authenticator 509 to verify that a user requesting one or more fonts should be provided access to the fonts (e.g., based on a service subscription, rental period, etc.).

In general, the interface frontend 506 may receive requests from and send responses to the client device 502. For instance, the hosted storage service 520 may be implemented as a Web Service with a corresponding set of Web Service Application Programming Interfaces (APIs). The Web Service APIs may be implemented, for example, as a Representational State Transfer (REST)-based HTTP interface or a Simple Object Access Protocol (SOAP)-based interface. Interface frontend 506 may receive messages from the client 502 and parse the requests into a format usable by the hosted storage service 520, such as a remote procedure call (RPC) to an interface backend 508. The interface frontend 506 may write responses generated by the hosted storage service 520 for transmission to the client 502. In some implementations, multiple interface frontends 506 may be implemented, for example to support multiple access protocols.

The interface frontend 506 may include a graphical front end, for example to display on a web browser for data access. The interface frontend 506 may include a sub-system to enable managed uploads and downloads of large files (e.g., for functionality such as pause, resume, and recover from time-out). The interface frontend 506 may monitor load information and update logs, for example to track and protect against denial of service (DOS) attacks.

As described above, the Web Service API may be a REST-based HTTP interface. In a REST-based interface, a data resource is accessed as a resource, uniquely named using a uniform resource identifier (URI), and the client application 503 and service 520 exchange representations of resource state using a defined set of operations. For example, requested actions may be represented as verbs, such as by HTTP GET, PUT, POST, HEAD, and DELETE verbs. The GET verb may be used to retrieve a resource, while the HEAD verb may be used to retrieve information about a resource without retrieving the resource itself. The DELETE verb may be used to delete a resource from the hosted storage service 520. The PUT and POST verbs may be used to upload a resource to the service 520. PUT requests may come from the client 502 and contain authentication and authorization credentials and resource metadata in a header, such as an HTTP header. POST requests may be received when a client 502 wants to upload from a web browser form. The form POST upload protocol for the hosted storage service 520 may involve multiple form fields to provide authentication, authorization, and resource metadata. More generally, any of the API requests may include credentials for authentication and authorization, for example in a header of the request. An authorization header may be included in the REST requests, which may include an access key to identify the entity sending the request.

Alternatively, or additionally, a user may be authenticated based on credentials stored in a browser cookie, which may be appended to the API requests. If no valid cookie is present, a redirect to an authentication frontend may be generated, and the authentication frontend may be used to generate the browser cookie. The authentication frontend may be used by systems and services in addition to the hosted storage service 520 (e.g., if the organization operating the hosted storage service 520 also operates other web services such as email service). A user may also or alternatively be authenticated based on authentication credentials from an external credentialing service or an external service that includes credentialing functionality. User or group identifier information may be calculated from the external service's credential information. Requests sent by the client 502 to the interface frontend 506 may be translated and forwarded to the external service for authentication.

In general, resources stored in the hosted storage service 520 may be referenced by resource identifiers. The hosted storage service 520 may define namespaces to which a valid resource identifier must conform. For example, the namespace may require that resource identifiers be a sequence of Unicode characters whose UTF-8 encoding is at most 1024 bytes long. As another example, the namespace may require that resource identifiers be globally unique identifiers (GUIDs), which may be 128-bit integers.

Resources (e.g., objects such as font data) may be stored in hosted storage service 520 in buckets. In some examples, each bucket is uniquely named in the hosted storage service 520, each data resource is uniquely named in a bucket, and every bucket and data resource combination is unique. Data resources may be uniquely identified by a URI that includes the bucket name and the resource name, and identifies the hosted storage service 520. For example, a resource named “long/song.mp3” in a bucket named “music” could be specified using a URI pattern such as http://s.hostedstoragesystem.com/music/long/song.mp3 or http://music.s.hostedstoragesystem.com/long/song.mp3. Alternatively, the user of the client 502 may create a bucket named my.music.org, publish a CNAME alias redirected to http://music.s.hostedstoragesystem.com, and address the resource as http://my.music.org/long/song.mp3. In some examples, buckets do not nest.

The interface backend 508 along with the authenticator 509 may handle request authentication and authorization, may manage data and metadata, and may track activity such as for billing. As one example, the interface backend 508 may query the authenticator 509 when a request for one or more fonts is received. The interface backend 508 may also provide additional or alternative functionality. For example, the interface backend 508 may provide functionality for independent frontend / backend scaling for resource utilization and responsiveness under localized heavy loads. Data management may be encapsulated in the interface backend 508 while communication serving may be encapsulated in the interface frontend 506. The interface backend 508 may isolate certain security mechanisms from the client-facing interface frontend 506.

The interface backend 508 may expose an interface usable by both the interface frontend 506 and other systems. In some examples, some features of the interface backend 508 are accessible only by an interface frontend (not shown) used by the owners of the hosted storage service 520 (internal users). Such features may include those needed for administrative tasks (e.g., resolving a resource reference to a low level disk address). The interface backend 508 may handle request authentication (e.g., ensuring a user's credentials are valid) and authorization (e.g., verifying that a requested operation is permitted). The interface backend may also provide encryption and decryption services to prevent unauthorized access to data, even by internal users.

The interface backend 508 may manage metadata 516 associated with data resources, for example in a MySQL database or BigTable. User-specified names labeling the buckets can be completely defined within the metadata 516, and resource metadata 516 can map a resource name to one or more datastores 512 storing the resource. The metadata 516 can also contain bucket and resource creation times, resource sizes, hashes, and access control lists 518 (ACL 518) for both buckets and resources. The interface backend 508 can log activity and track storage consumption to support accounting for billing and chargebacks. In some examples, this includes quota monitoring in each dimension in which customers are charged (e.g., reads, writes, network transfers, total storage in use).

The ACLs 518 may generally define who is authorized to perform actions on corresponding buckets or resources, and the nature of the permitted actions. The ACLs 518 may be an unordered list of {scope, role} pairs, plus Boolean flags. The scope may define a user or group of users and the role may define the access permissions for the user or group. In some examples, the union of all {scope, role} pairs may define access rights. In some examples, more specific {scope, role} pairs override more general ones.

The storage backend 510 may contain multiple datastores 512a-512c. Although three datastores 512 are shown, more or fewer are possible. Each of the datastores 512a-512c may store data resources 514a-514c in a particular format. For example, data store 512a may store a data resource 514a as a Binary Large Object (BLOB), data store 512b may store a data resource 514b in a distributed file system (e.g., Network File System), and data store 512c may store a data resource 514c in a database (e.g., MySQL).

FIG. 6 shows an example of example computer device 600 and example mobile computer device 650, which can be used to implement the techniques described herein. For example, a portion or all of the operations of the font distribution manager 216 (shown in FIG. 2) may be executed by the computer device 600 and/or the mobile computer device 650. Computing device 600 is intended to represent various forms of digital computers, including, e.g., laptops, desktops, workstations, personal digital assistants, servers, blade servers, mainframes, and other appropriate computers. Computing device 650 is intended to represent various forms of mobile devices, including, e.g., personal digital assistants, cellular telephones, smartphones, and other similar computing devices. The components shown here, their connections and relationships, and their functions, are meant to be examples only, and are not meant to limit implementations of the techniques described and/or claimed in this document.

Computing device 600 includes processor 602, memory 604, storage device 606, high-speed interface 608 connecting to memory 604 and high-speed expansion ports 610, and low speed interface 612 connecting to low speed bus 614 and storage device 606. Each of components 602, 604, 606, 608, 610, and 612, are interconnected using various busses, and can be mounted on a common motherboard or in other manners as appropriate. Processor 602 can process instructions for execution within computing device 600, including instructions stored in memory 604 or on storage device 606 to display graphical data for a GUI on an external input/output device, including, e.g., display 616 coupled to high speed interface 608. In other implementations, multiple processors and/or multiple buses can be used, as appropriate, along with multiple memories and types of memory. Also, multiple computing devices 600 can be connected, with each device providing portions of the necessary operations (e.g., as a server bank, a group of blade servers, or a multi-processor system).

Memory 604 stores data within computing device 600. In one implementation, memory 604 is a volatile memory unit or units. In another implementation, memory 604 is a non-volatile memory unit or units. Memory 604 also can be another form of computer-readable medium, including, e.g., a magnetic or optical disk.

Storage device 606 is capable of providing mass storage for computing device 600. In one implementation, storage device 606 can be or contain a computer-readable medium, including, e.g., a floppy disk device, a hard disk device, an optical disk device, or a tape device, a flash memory or other similar solid state memory device, or an array of devices, including devices in a storage area network or other configurations. A computer program product can be tangibly embodied in a data carrier. The computer program product also can contain instructions that, when executed, perform one or more methods, including, e.g., those described above. The data carrier is a computer- or machine-readable medium, including, e.g., memory 604, storage device 606, memory on processor 602, and the like.

High-speed controller 608 manages bandwidth-intensive operations for computing device 600, while low speed controller 612 manages lower bandwidth-intensive operations. Such allocation of functions is an example only. In one implementation, high-speed controller 608 is coupled to memory 604, display 616 (e.g., through a graphics processor or accelerator), and to high-speed expansion ports 610, which can accept various expansion cards (not shown). In the implementation, low-speed controller 612 is coupled to storage device 606 and low-speed expansion port 614. The low-speed expansion port, which can include various communication ports (e.g., USB, Bluetooth®, Ethernet, wireless Ethernet), can be coupled to one or more input/output devices, including, e.g., a keyboard, a pointing device, a scanner, or a networking device including, e.g., a switch or router, e.g., through a network adapter.

Computing device 600 can be implemented in a number of different forms, as shown in the figure. For example, it can be implemented as standard server 620, or multiple times in a group of such servers. It also can be implemented as part of rack server system 624. In addition or as an alternative, it can be implemented in a personal computer including, e.g., laptop computer 622. In some examples, components from computing device 600 can be combined with other components in a mobile device (not shown), including, e.g., device 650. Each of such devices can contain one or more of computing device 600, 650, and an entire system can be made up of multiple computing devices 600, 650 communicating with each other.

Computing device 650 includes processor 652, memory 664, an input/output device including, e.g., display 654, communication interface 666, and transceiver 668, among other components. Device 650 also can be provided with a storage device, including, e.g., a microdrive or other device, to provide additional storage. Each of components 650, 652, 664, 654, 666, and 668, are interconnected using various buses, and several of the components can be mounted on a common motherboard or in other manners as appropriate.

Processor 652 can execute instructions within computing device 650, including instructions stored in memory 664. The processor can be implemented as a chipset of chips that include separate and multiple analog and digital processors. The processor can provide, for example, for coordination of the other components of device 650, including, e.g., control of user interfaces, applications run by device 650, and wireless communication by device 650.

Processor 652 can communicate with a user through control interface 658 and display interface 656 coupled to display 654. Display 654 can be, for example, a TFT LCD (Thin-Film-Transistor Liquid Crystal Display) or an OLED (Organic Light Emitting Diode) display, or other appropriate display technology. Display interface 656 can comprise appropriate circuitry for driving display 654 to present graphical and other data to a user. Control interface 658 can receive commands from a user and convert them for submission to processor 652. In addition, external interface 662 can communicate with processor 642, so as to enable near area communication of device 650 with other devices. External interface 662 can provide, for example, for wired communication in some implementations, or for wireless communication in other implementations, and multiple interfaces also can be used.

Memory 664 stores data within computing device 650. Memory 664 can be implemented as one or more of a computer-readable medium or media, a volatile memory unit or units, or a non-volatile memory unit or units. Expansion memory 674 also can be provided and connected to device 650 through expansion interface 672, which can include, for example, a SIMM (Single In Line Memory Module) card interface. Such expansion memory 674 can provide extra storage space for device 650, or also can store applications or other data for device 650. Specifically, expansion memory 674 can include instructions to carry out or supplement the processes described above, and can include secure data also. Thus, for example, expansion memory 674 can be provided as a security module for device 650, and can be programmed with instructions that permit secure use of device 650. In addition, secure applications can be provided through the SIMM cards, along with additional data, including, e.g., placing identifying data on the SIMM card in a non-hackable manner.

The memory can include, for example, flash memory and/or NVRAM memory, as discussed below. In one implementation, a computer program product is tangibly embodied in a data carrier. The computer program product contains instructions that, when executed, perform one or more methods, including, e.g., those described above. The data carrier is a computer- or machine-readable medium, including, e.g., memory 664, expansion memory 674, and/or memory on processor 652, which can be received, for example, over transceiver 668 or external interface 662.

Device 650 can communicate wirelessly through communication interface 666, which can include digital signal processing circuitry where necessary. Communication interface 666 can provide for communications under various modes or protocols, including, e.g., GSM voice calls, SMS, EMS, or MMS messaging, CDMA, TDMA, PDC, WCDMA, CDMA2000, or GPRS, among others. Such communication can occur, for example, through radio-frequency transceiver 968. In addition, short-range communication can occur, including, e.g., using a Bluetooth®, WiFi, or other such transceiver (not shown). In addition, GPS (Global Positioning System) receiver module 670 can provide additional navigation- and location-related wireless data to device 650, which can be used as appropriate by applications running on device 650.

Device 650 also can communicate audibly using audio codec 660, which can receive spoken data from a user and convert it to usable digital data. Audio codec 660 can likewise generate audible sound for a user, including, e.g., through a speaker, e.g., in a handset of device 650. Such sound can include sound from voice telephone calls, can include recorded sound (e.g., voice messages, music files, and the like) and also can include sound generated by applications operating on device 650.

Computing device 650 can be implemented in a number of different forms, as shown in the figure. For example, it can be implemented as cellular telephone 680. It also can be implemented as part of smartphone 682, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to a computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the systems and techniques described here can be implemented on a computer having a display device (e.g., a CRT (cathode ray tube) or LCD (liquid crystal display) monitor) for displaying data to the user and a keyboard and a pointing device (e.g., a mouse or a trackball) by which the user can provide input to the computer. Other kinds of devices can be used to provide for interaction with a user as well; for example, feedback provided to the user can be a form of sensory feedback (e.g., visual feedback, auditory feedback, or tactile feedback); and input from the user can be received in a form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a user interface or a Web browser through which a user can interact with an implementation of the systems and techniques described here), or a combination of such back end, middleware, or front end components. The components of the system can be interconnected by a form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In some implementations, the engines described herein can be separated, combined or incorporated into a single or combined engine. The engines depicted in the figures are not intended to limit the systems described here to the software architectures shown in the figures.

Processes described herein and variations thereof (referred to as “the processes”) include functionality to ensure that party privacy is protected. To this end, the processes may be programmed to confirm that a user's membership in a social networking account is publicly known before divulging, to another party, that the user is a member. Likewise, the processes may be programmed to confirm that information about a party is publicly known before divulging that information to another party, or even before incorporating that information into a social graph.

A number of embodiments have been described. Nevertheless, it will be understood that various modifications can be made without departing from the spirit and scope of the processes and techniques described herein. In addition, the logic flows depicted in the figures do not require the particular order shown, or sequential order, to achieve desirable results. In addition, other steps can be provided, or steps can be eliminated, from the described flows, and other components can be added to, or removed from, the described systems. Accordingly, other embodiments are within the scope of the following claims.

What is claimed is:

1. A computing device-implemented method comprising:
receiving, at a font service provider, a request from a computing device for one or more fonts;
authenticating the user of the computing device from the received request; and
providing access to data representative of the one or more fonts identified in the received request for use by the computing device, wherein the data representative of the one or more fonts resides in a predefined portion of memory assigned to the user of the computing device.

2. The computing device-implemented method of claim 1, wherein the one or more fonts identified in the received request supplement one or more other fonts residing in a portion of memory for fonts of the computing device.

3. The computing device-implemented method of claim 1, wherein the predefined portion of memory assigned to the user is included in the computing device.

4. The computing device-implemented method of claim 1, wherein the predefined portion of the memory assigned to the user is located at the font service provider.

5. The computing device-implemented method of claim 1, wherein the predefined portion of the memory assigned to the user is located at another service provider.

6. The computing device-implemented method of claim 1, wherein authenticating the user of the computing device includes determining if the user has a current subscription for access to fonts of the font service provider.

7. The computing device-implemented method of claim 1, wherein providing access to data representative of the one or more fonts identified in the received request includes adding the data representative of the one or more fonts to the predefined portion of memory assigned to the user, which is included in the computing device.

8. The computing device-implemented method of claim 1, wherein authenticating the user of the computing device includes determining which fonts are accessible based upon a subscription of the user.

9. The computing device-implemented method of claim 1, wherein authenticating the user of the computing device includes determining the status of a rental period.

10. A system comprising:
a first computing device comprising:
a memory configured to store instructions; and
a processor to execute the instructions to perform a method comprising:
receiving, at a font service provider, a request from a second computing device for one or more fonts,
authenticating the user of the second computing device from the received request, and
providing access to data representative of the one or more fonts identified in the received request for use by the second computing device, wherein the data representative of the one or more fonts resides in a predefined portion of memory assigned to the user of the second computing device.

11. The system of claim 10, wherein the one or more fonts identified in the received request supplement one or more other fonts residing in a portion of memory for fonts of the second computing device.

12. The system of claim 10, wherein the predefined portion of memory assigned to the user is included in the second computing device.

13. The system of claim 10, wherein the predefined portion of the memory assigned to the user is located at the font service provider.

14. The system of claim 10, wherein the predefined portion of the memory assigned to the user is located at another service provider.

15. The system of claim 10, wherein authenticating the user of the second computing device includes determining if the user has a current subscription for access to fonts of the font service provider.

16. The system of claim 10, wherein providing access to data representative of the one or more fonts identified in the received request includes adding the data representative of the one or more fonts to the predefined portion of memory assigned to the user, which is included in the second computing device.

17. The system of claim 10, wherein authenticating the user of the second computing device includes determining which fonts are accessible based upon a subscription of the user.

18. The system of claim 10, wherein authenticating the user of the computing device includes determining the status of a rental period.

19. One or more computer readable media storing instructions that are executable by a processing device, and upon such execution cause the processing device to perform operations comprising:
receiving, at a font service provider, a request from a computing device for one or more fonts;
authenticating the user of the computing device from the received request; and
providing access to data representative of the one or more fonts identified in the received request for use by the computing device, wherein the data representative of the one or more fonts resides in a predefined portion of memory assigned to the user of the computing device.

20. The computer readable media of claim 19, wherein the one or more fonts identified in the received request supplement one or more other fonts residing in a portion of memory for fonts of the computing device.

21. The computer readable media of claim 19, wherein the predefined portion of memory assigned to the user is included in the computing device.

22. The computer readable media of claim 19, wherein the predefined portion of the memory assigned to the user is located at the font service provider.

23. The computer readable media of claim 19, wherein the predefined portion of the memory assigned to the user is located at another service provider.

24. The computer readable media of claim 19, wherein authenticating the user of the computing device includes determining if the user has a current subscription for access to fonts of the font service provider.

25. The computer readable media of claim 19, wherein providing access to data representative of the one or more fonts identified in the received request includes adding the data representative of the one or more fonts to the predefined portion of memory assigned to the user, which is included in the computing device.

26. The computer readable media of claim 19, wherein authenticating the user of the computing device includes determining which fonts are accessible based upon a subscription of the user.

27. The computer readable media of claim 19, wherein authenticating the user of the computing device includes determining the status of a rental period.
